(19) United States
(12) Patent Application Publication
(10) Pub. No.: US 2012/0301655 A1
(43) Pub. Date: Nov. 29, 2012

(54) METHOD, SYSTEM, AND APPARATUS FOR A POINT PROTECTION DEVICE

(76) Inventor: Samuel T. Artioli, Capitola, CA (US)

(21) Appl. No.: 13/478,785

(22) Filed: May 23, 2012

Related U.S. Application Data
(60) Provisional application No. 61/489,029, filed on May 23, 2011.

(51) Int. Cl. B32B 3/02

(52) U.S. Cl. 428/68

(57) ABSTRACT

The present invention contemplates a variety of methods, systems, techniques, and apparatuses for creating a point protection device. The point protection device attaches at the tip of a point that is sharp, rough, or otherwise likely to cause harm or damage. The point protection device prevents the point or tip from causing physical damage or pain by eliminating its ability to puncture or scratch skin. Additionally, the point protection device prevents the point from damaging material or surfaces with which the point may come in contact. The point protection device can also be used for ornamentation and allows for variations in point diameters.

### FIELD OF INVENTION

The present invention relates to protective devices and more specifically to a point protection device used to cover a sharp or rough point or tip of an object.

### BACKGROUND OF THE INVENTION

Exposed tips or points of objects have the potential to cause pain and possibly infection if they are allowed to puncture skin. Exposed tips or points of objects also have the potential to scratch or mar an object that the point was not meant to come in contact with. A typical example is a sewing needle. The point of a sewing needle is sharp. There exist pin cushions to protect the point and keep it from being touched while not in use, as well as thimbles that are used to protect the fingers while sewing. Another example is the medical needle, which is protected before and after use by a variety of different methods, such as a plastic encasing.

However, present methods used to cover certain tips/points are not practical for other tips/points of objects. The present invention addresses a method to cover rough and sharp tips/points of guitar strings, for example. Guitar strings are stainless steel and range from approximately 0.010″ to 0.055″ in diameter. When a guitar is “strung”, the string is attached at the bridge of the guitar, run up the neck, pulled over the nut, and spun through and around a tuning peg. Once this string is tightened, the excess string can be curled up upon itself, or cut. Usually the string is cut, but either way, there is left an excess of string with a sharp point. These sharp points can cause pain and injury when someone is accidentally punctured with them. These sharp points may also cause damage to surfaces with which they come into contact.

### SUMMARY OF THE INVENTION

The present invention contemplates a variety of methods, systems, and apparatuses for a point protection device. The point protection device attaches at the tip of a point that is sharp, rough, or otherwise likely to cause harm or damage. The point protection device prevents the point or tip from causing physical damage or pain by eliminating its ability to puncture or scratch skin. Additionally, the point protection device prevents the point from damaging material or surfaces with which the point may come in contact. The point protection device can also be used for ornamentation and allows for variations in point diameters.

A first aspect of the present invention provides a point protection device, comprising an open protective shell and a soft core, capable of holding a point, positioned essentially inside the protective shell.

A second aspect of the present invention provides a point protection device, comprising a protective shell capable of receiving a tip and an adjustable fastening piece.

A third aspect of the present invention provides a method of preventing injury and damage from points, comprising: identifying a point that is one or more of: sharp, rough, and likely to cause damage or injury; and securing a point protection device over the point.

A fourth aspect of the present invention provides a system for preventing injury and damage from points, comprising: a tough protective shell and a soft, easily punctured, slip-resistant core positioned substantially inside the protective shell.

### BRIEF DESCRIPTION OF DRAWINGS

These and other objects, features, and characteristics of the present invention will become more apparent to those skilled in the art from a study of the following detailed description in conjunction with the appended claims and drawings, all of which form a part of this specification. In the drawings:

FIG. 1 illustrates a top view of a point protection device according to an embodiment of the present invention.

FIG. 2 illustrates a side view of a point protection device according to an embodiment of the present invention.

FIG. 3 illustrates a bottom view of a point protection device according to an embodiment of the present invention.

FIG. 4 illustrates an angled view of a point protection device according to an embodiment of the present invention.

FIG. 5 illustrates a cross-sectional view of a point protection device according to an embodiment of the present invention.

FIG. 6 illustrates a cross-sectional view of a point protection device with a point inserted in the device according to an embodiment of the present invention.

FIG. 7 illustrates a top view of a shaped point protection device according to an embodiment of the present invention.

FIG. 8 illustrates a side view of a shaped point protection device according to an embodiment of the present invention.

FIG. 9 illustrates a bottom view of a shaped point protection device according to an embodiment of the present invention.

FIG. 10 illustrates a cross-sectional view of a shaped point protection device according to an embodiment of the present invention.

FIG. 11 depicts a method flow diagram according to an embodiment of the present invention.

FIG. 12 illustrates a cross-sectional view of a point protection device according to an embodiment of the present invention.

FIG. 13 illustrates a cross-sectional view of a point protection device with a point inserted in the device according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. When used, like numbering represents like elements.

### DETAILED DESCRIPTION OF THE INVENTION

The present invention solves the problem of covering up tips or points of varying diameters in a fast, convenient, and durable way. The inspiration for this invention comes from the guitar or, more specifically, guitar strings. When a guitar is “strung”, a stainless steel string or wire is stretched from the bridge of the guitar to a tuning peg, around which the string/wire is wound. Excess string/wire is cut or tightly wound and tucked next to the tuning peg. This leaves a sharp point or tip on which a user, player, or handler can injure him/herself should the point/tip puncture, prick, or scratch the skin of the user, causing pain and/or a wound. Furthermore, a sharp point/tip can damage a surface with which it comes in contact, such as a table or wall, should the head of the guitar rub against such a surface.

By using point protection devices, guitarists will shield their fingers from accidental puncturing by their guitar strings. These point protection devices will also make a guitar, or any stringed instrument that uses them, safer for children. The point protection device may also be used on non-stringed instruments having sharp points. For example, several varieties of wind instruments, including saxophones and clarinets, have sharp springs that can be capped with the point protection device.

In addition, the point protection device can also be used for ornamentation and may be made in a large variety of shapes, sizes, colors, and designs. For example point protection devices can be shaped as bullets, skulls, peace signs, flowers, etc.

Although inspired by the guitar, the present invention can also be used for any point or tip and allows the covering up of tips/points of varying diameters in a fast, convenient, and durable way.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. The terms user, player, handler, and guitarists are utilized interchangeably throughout this discussion. It should be understood that these terms refer to any person handling an object, such as, but not limited to, a guitar having sharp or rough points or tips. The terms point and tip are also used interchangeably throughout this discussion.

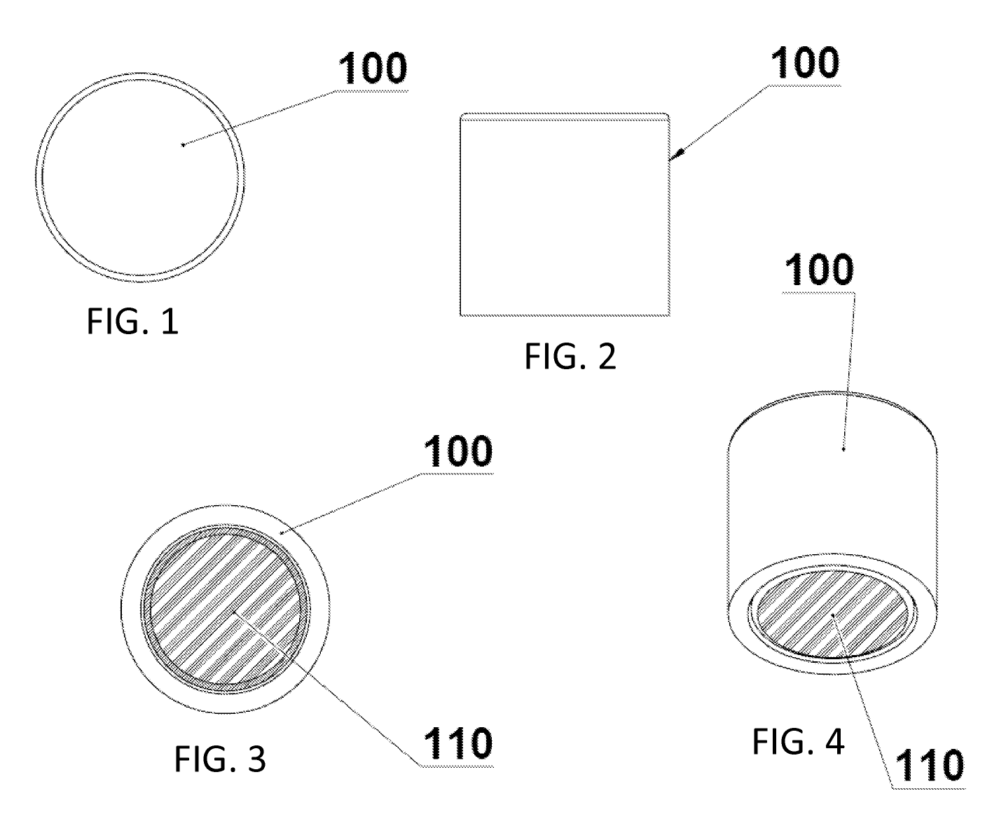

Referring now to FIGS. 1, 2, 3, and 4, a top, side, bottom, and angled view of a point protection device according to an embodiment of the present invention are illustrated, respectively. Protective shell 100 encases soft core 110 in this embodiment of the point protection device. In the embodiment depicted in FIGS. 1-4, protective shell 100 is cylindrical, covering the top and sides of soft core 110, and open on one end of said cylinder. This opening exposes soft core 110, which may receive points or tips of varying diameters. It is not necessary that the entirety of soft core 110 be placed within protective shell 100, only that a sufficient portion of soft core 110 be within protective shell 100 to prevent a tip/point lodged in soft core 110 from causing injury or damage by poking all the way through soft core 110. Therefore, in preferred embodiments, soft core 110 is mostly, essentially, or substantially in protective shell 100. Protective shell 100 may also be called a shield or guard.

Protective shell 100 comprises material not readily or easily punctured by a point. Examples of such materials include, but are not limited to, plastic, metal, wood, break-resistant glass, and various hard materials. Soft core 110, however, is readily punctured by the point, but holds the point in place once the point has been inserted into soft core 110. Examples of such materials include, but are not limited to, rubber, glue, cork, elastic substances, hyperelastic substances, viscous substances, and adhesive materials. Once in place, a point or tip cannot slip or move out of soft core 110 unless manually forced out by a user.

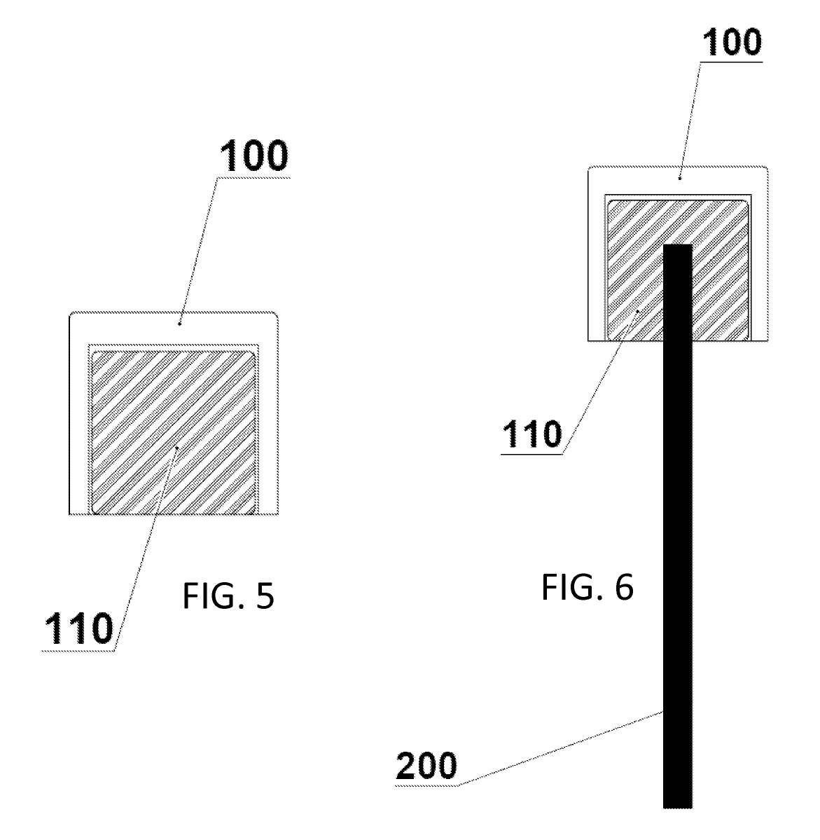

Referring now to FIGS. 5 and 6, a cross sectional view of a point protection device and a cross-sectional view of a point protection device with a point inserted in the device according to an embodiment of the present invention, are illustrated. Point 200 is inserted into soft core 110, which is penetrated with ease. However, protective shell 100, encircling soft core 110, is not able to be penetrated by point 200. Once point 200 enters soft core 110 inwards, point 200 becomes wedged, anchored, adhered, stuck, or otherwise fastened within soft core 110, such that the point protection device will not slip off point 200 or otherwise become easily detached. The assembly of an obscured point and point protection device prevents injuries to skin and fingers such as pricks, punctures and scratches, as well as physical damage such as marred surfaces. Soft core 110 accommodates points 200 in a variety of diameters or widths, ranging from very small to just short of the diameter of soft core 110 itself. The soft, pliable nature of the material used for soft core 110 also allows the point protection device to be reused if desired.

An adjustable fastening piece may also replace soft core 110 and be used to secure point 200. A sufficient portion of the adjustable fastening piece is contained within protective shell 100 such that when point 200 is secured within protective shell 100, the possibility of skin-to-point 200 contact is blocked by protective shell 100. Furthermore, because the fastening piece is adjustable, a point protection device having the adjustable fastening piece may be adjusted to accommodate tips/points of various diameters.

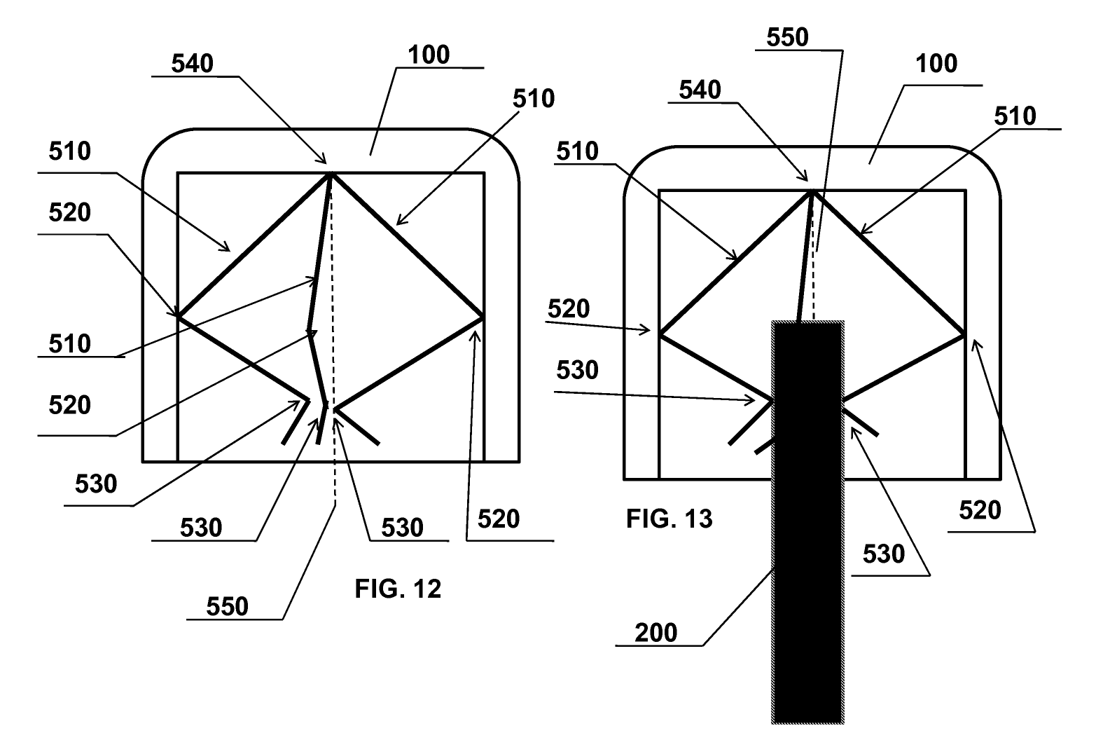

An example of an adjustable fastening piece may include, for example, but is not limited to, a miniature clothespin-like piece within protective shell 100 which pinches point 200 in order to keep point 200 in place and whose sides move to accommodate points of varying diameter or width. As shown in FIGS. 12 and 13, in some embodiments, the adjustable fastening piece may comprise three identical arms 510 attached to a center point 540 of a ceiling of the shell 500. The arms may extend outwardly from the center point 540 at a distance of 120 degrees apart from one another (this distance will vary if more or fewer arms are provided in an implementation of the invention, and the scope of the invention includes any such angle). The arms may be configured to each have two joints (or bends) 520 and 530, one bending inwardly (shown as 520) and one outwardly (shown as 530) in relation to a longitudinal axis 550 of the shell 100, such that the joints 530 of the arms 510 are disposed in close proximity, i.e. substantially together, at longitudinal axis 540 to grasp an inserted tip 200. When a tip 200 is inserted along the longitudinal axis 540 between the arms 510, the arms 510 open around the tip 200, and joints 530 engage the tip 200 due to the pressure from the arms 510 against the inserted tip 200. In some embodiments, the arms 510 may be attached to the side wall of the shell 100 at joints 520. The arms 510 may be made of any substantially pliable material, such as aluminum, plastic, and any other metal or other material which will allow the arms 510 to open slightly around an inserted tip 200, thereby adjusting to the width of an inserted tip 200. It will be recognized that in some embodiments, the point protection device may comprise more or fewer arms, and the arms may comprise more or fewer joints.

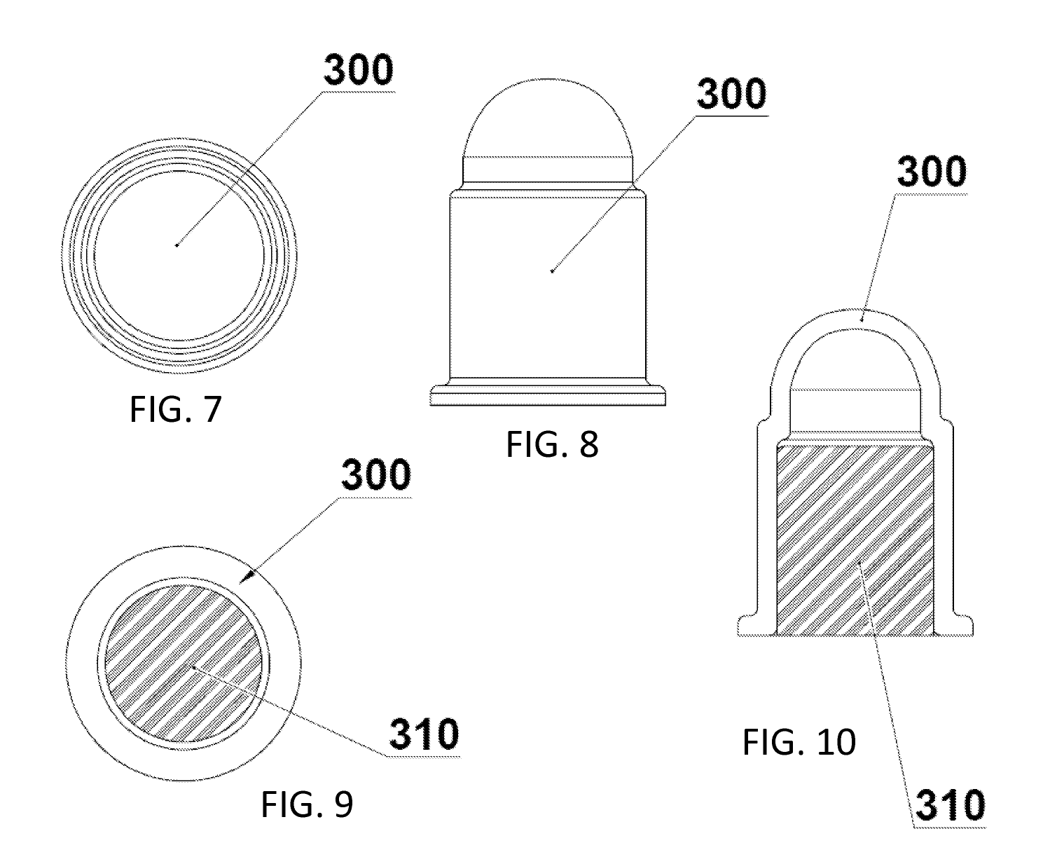

Referring now to FIGS. 7, 8, 9, and 10, a top, side, bottom, and cross-sectional view of a shaped point protection device according to an embodiment of the present invention is illustrated. Shell 300 may be designed for ornamentation as well as for protection. In the depicted embodiment, shell 300 has the shape of a bullet, although any cast or molded shape can be used. For example, shell 300 can also be shaped as, but not limited to: skulls, peace signs, flowers, sports items and so forth. In some embodiments, the ornamentation is hollowed out and filled with soft core 310, which may be molded to fit the size and shape of shell 300.

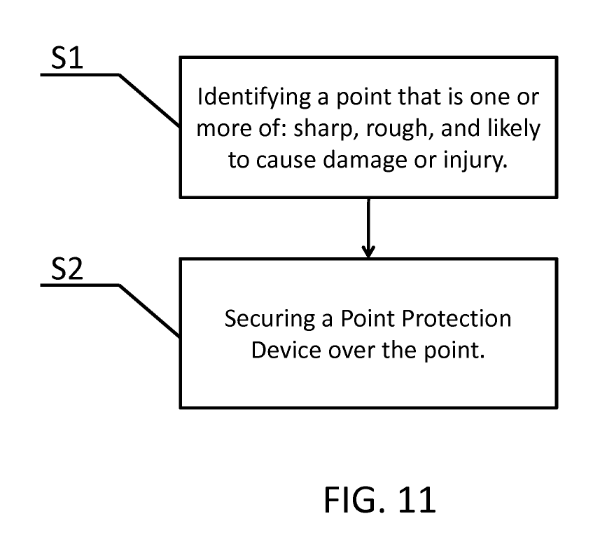

Referring now to FIG. 11, a method flow diagram for a method of preventing injury and damage from points according to an embodiment of the present invention is shown. In step 51, a point that is one or more of: sharp, rough, and likely to cause damage or injury is identified. In step S2 a point protection device is secured over the point.

In addition to the above mentioned examples, various other modifications and alterations of the present invention may be made without departing from the present invention. While the invention has been particularly shown and described in conjunction with preferred embodiments thereof, it will be appreciated that variations and modifications will occur to those skilled in the art. Accordingly, the above disclosure is not to be considered as limiting, and the appended claims are to be interpreted as encompassing the true spirit and the entire scope of the invention.

I claim:

1. A point protection device, comprising:
an open protective shell; and
a soft core, capable of holding a point, positioned essentially inside the protective shell.

2. The point protection device of claim 1, the soft core being disposed within the open protective shell such that the point can be inserted into the core with the open protective shell shielding a finger of a user from injury.

3. The point protection device of claim 1, the soft core comprising a material readily punctured by the point, and the open protective shell comprising a material not readily punctured by the point.

4. The point protection device of claim 1, the soft core being penetrable by the point whose diameter size range is determined by the size of the soft core.

5. The point protection device of claim 2, the soft core comprising a material that holds the point in place once said point has been inserted into the soft core.

6. The point protection device of claim 1, the open protective shell comprising at least one of: plastic, metal, wood, glass, and a hard synthetic material.

7. The point protection device of claim 1, the soft core comprising at least one of:
rubber, glue, an elastic substance, a hyperelastic substance, a viscous substance, and an adhesive material.

8. The point protection device of claim 1, the shell comprising an ornamental shape.

9. A point protection device, comprising:
a protective shell configured to receive a tip; and
an adjustable fastening piece.

10. The point protection device of claim 9, the protective shell substantially covering the fastening piece such that the tip can be inserted and secured into the fastening piece while the protective shell protects skin.

11. The point protection device of claim 9, the protective shell comprising at least one of: plastic, metal, wood, glass, and a hard synthetic material.

12. The point protection device of claim 9, the fastening piece being adjustable to allow for variations in tip diameter.

13. The point protection device of claim 9, the shell comprising an ornamental shape.

14. A method of preventing injury and damage from points, comprising:
identifying a point that is at least one of: sharp, rough, and likely to cause damage or injury; and
securing a point protection device over the point.

15. The method of claim 14, wherein the point protection device comprises a hard protective shell and a soft, readily punctured, movement-resistant core positioned essentially inside the protective shell.

16. The method of claim 14, further comprising using an object having the point, wherein the point protection device prevents one of: injury and physical damage.

17. The method of claim 14, the point protection device being capable of accommodating a range of point diameters.

18. A system for preventing injury and damage from points, comprising:
a tough protective shell; and
a soft, easily punctured, slip-resistant core positioned substantially inside the protective shell.

19. The system of claim 18, wherein a point is pushed into the core, obscuring the point from touch.

20. The system of claim 18, the core being capable of accommodating a range of point diameters.
